(19) United States
(12) Patent Application Publication
(10) Pub. No.: US 2026/0203220 A1
(43) Pub. Date: Jul. 16, 2026

(54) CACHE AWARE KERNEL PROCESSING

(71) Applicant: NVIDIA Corporation, Santa Clara, CA (US)

(72) Inventors: Yaosheng Fu, Santa Clara, CA (US); Jack Kosaian, Coralville, IA (US)

(21) Appl. No.: 19/026,019

(22) Filed: Jan. 16, 2025

(51) Int. Cl. G06F 12/0802; G06T 1/60

(52) U.S. Cl. CPC G06F 12/0802; G06T 1/60

(57) ABSTRACT

Retrieving data blocks from a memory cache on a processor unit to be used by more than one compute thread can be improved to increase data reuse and reduce power consumption. Conventionally, data blocks are retrieved using a standard data retrieval model regardless of how the data is reused by the multiple compute threads accessing that data. By dynamically using a combination of dataflow retrieval models, a more optimized process can be implemented increasing data reuse and lowering power consumption of the processor unit. The dataflow retrieval models can be adaptive swizzling, continuous rasterization, alternating k-order, periodic compute thread array synchronization, or explicit tile eviction. As the size and number of memory caches increase on a processing unit, as well as the number of logic units and streaming multiprocessors, these optimizations become more valuable to overall efficiency.

### TECHNICAL FIELD

This application is directed, in general, to improving the operation of processor units and, more specifically, to managing processor cache memory.

### BACKGROUND

Many techniques have been employed to manage resources on a processor unit (such as a central processing unit (CPU), a graphics processing unit (GPU), or other types of processors). As the cache size increases on the processor, managing the way data is stored and retrieved from the cache takes on a larger role in affecting the overall performance of the processor. Prior kernel designs have observed that rasterizing compute thread arrays (CTAs) into a “square” shape within each wave increases L2 data sharing and decreases DRAM traffic. This observation does not account for new hardware and software features such as larger L2 capacities, cooperative grid array (CGA) clusters, variety in input precisions, and sparsity within a kernel. Current processes provide a few simple heuristics for rasterization options, leading to sub-optimal L2 data sharing.

### SUMMARY

In one aspect, a method is disclosed. In one embodiment, the method includes (1) receiving input parameters, wherein the input parameters specify one or more algorithms to be used for a cache-aware dataflow within a processor unit, (2) loading data into the memory cache during an execution of an application executing on the processor unit, and (3) retrieving the data utilizing the one or more algorithms, wherein the data is stored using a swizzle model and the data is retrieved in data blocks, where the one or more algorithms are one or more of an adaptive swizzling model, a continuous rasterization model, an alternating k-order model, a periodic compute thread array (CTA) synchronization model, or an explicit tile eviction model.

In a second aspect, a system is disclosed. In one embodiment, the system includes (1) a memory cache, capable of storing data from an application, and (2) a logic unit, capable of executing at least one compute thread, wherein the compute thread requests data using data blocks from the memory cache using a set of dataflow techniques that include at least one of an adaptive swizzling model, a continuous rasterization model, an alternating k-order model, a periodic compute thread array (CTA) synchronization model, or an explicit tile eviction model.

In a third aspect, non-transitory computer program product having a series of operating instructions stored on a non-transitory computer-readable medium that directs data retrieval from a memory cache of a processor unit when executed is disclosed. In one embodiment, the non-transitory computer program product includes (1) receiving input parameters, wherein the input parameters specify one or more algorithms to be used as a cache-aware dataflow within the processor unit, (2) loading data into the memory cache during an execution of an application executing on the processor unit, and (3) retrieving the data utilizing the one or more algorithms, wherein the data is stored using a swizzle model and the data is retrieved in data blocks, where the one or more algorithms are one or more of an adaptive swizzling model, a continuous rasterization model, an alternating k-order model, a periodic compute thread array (CTA) synchronization model, or an explicit tile eviction model.

In a fourth aspect, a processor unit is disclosed. In one embodiment the processor unit includes (1) a memory cache, capable of storing data from an execution of an application by a compute thread of the processor unit, (2) a logic unit, capable of executing the compute thread and requesting the data from the memory cache, and (3) a dataflow processor, capable of retrieving one or more blocks of data from the memory cache when requested by the logic unit, wherein the dataflow processor utilizes a data retrieval model comprising one or more of an adaptive swizzling model, a continuous rasterization model, an alternating k-order model, a periodic compute thread array (CTA) synchronization model, or an explicit tile eviction model.

In a fifth aspect, a processing unit system is disclosed. In one embodiment the processing unit system includes (1) a memory cache, capable of storing data from an execution of an application by a compute thread of a processor unit, (2) a logic unit, capable of executing the compute thread and requesting the data from the memory cache, (3) a dataflow processor, capable of retrieving one or more blocks of data from the memory cache when requested by the logic unit, wherein the dataflow processor utilizes a data retrieval model comprising one or more of an adaptive swizzling model, a continuous rasterization model, an alternating k-order model, a periodic compute thread array (CTA) synchronization model, or an explicit tile eviction model, and (4) a global memory, capable of storing at least one atomic counter used by at least one model in the data retrieval model.

### BRIEF DESCRIPTION

Reference is now made to the following descriptions taken in conjunction with the accompanying drawings, in which:

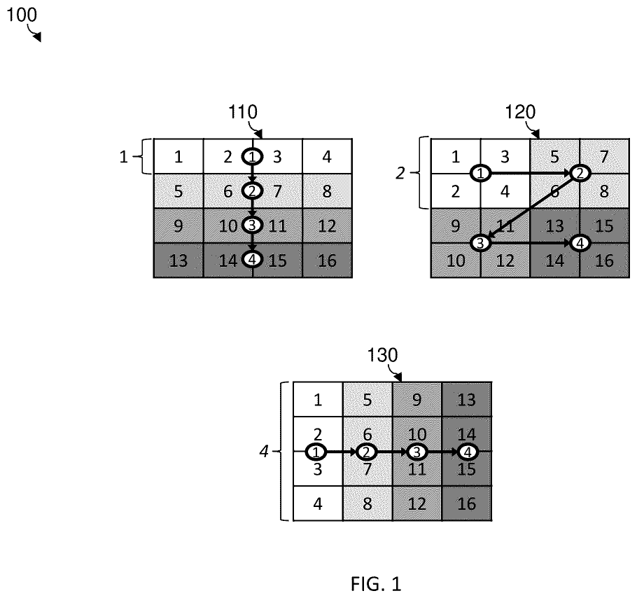

FIG. 1 is an illustration of a diagram of example swizzling models;

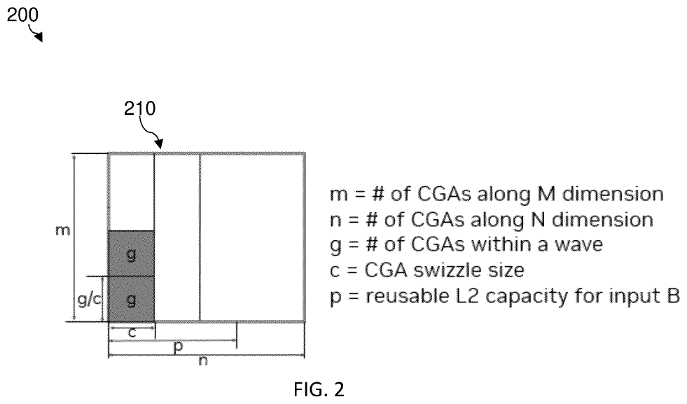

FIG. 2 is an illustration of a diagram of an example adaptive swizzling model;

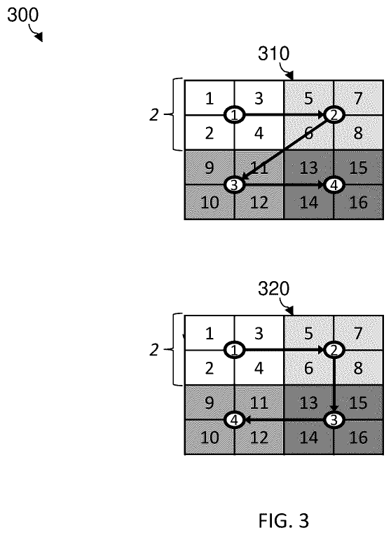

FIG. 3 is an illustration of a diagram of an example continuous rasterization model;

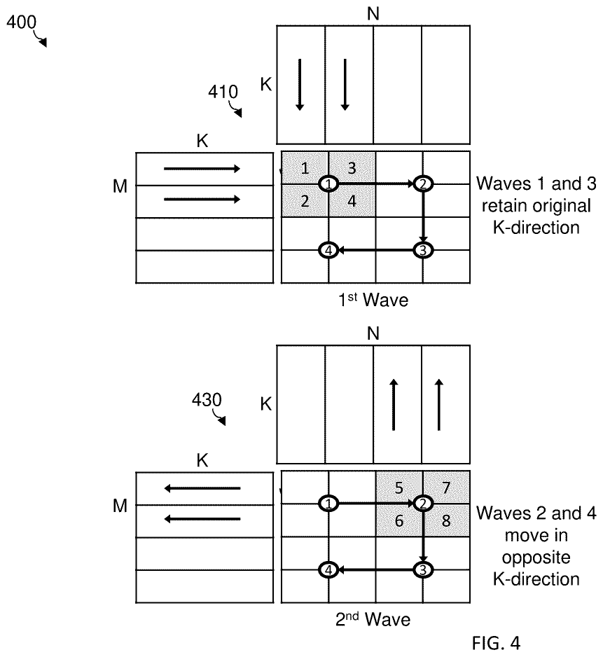

FIG. 4 is an illustration of a diagram of an example alternating K order model;

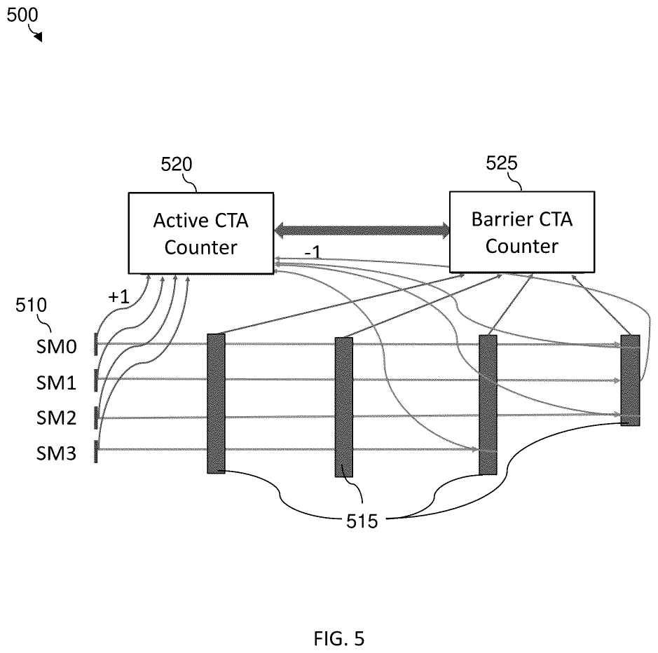

FIG. 5 is an illustration of a diagram of an example periodic CTA synchronization model;

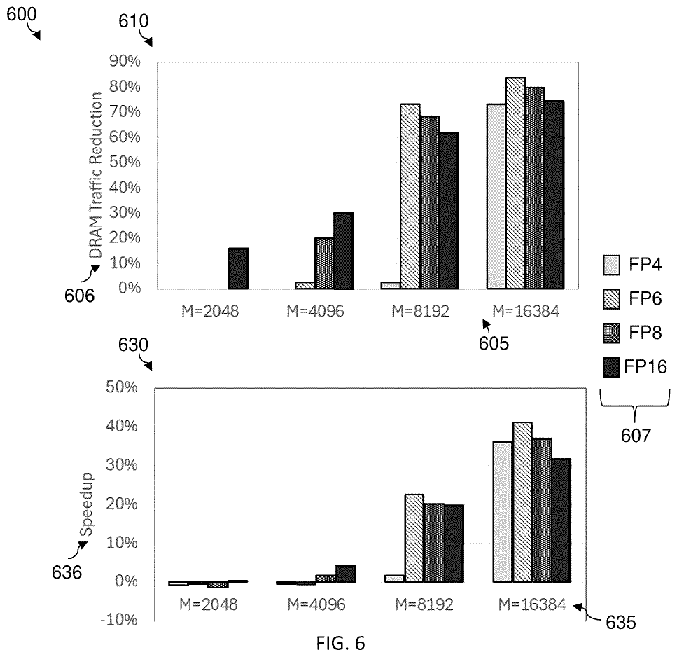

FIG. 6 is an illustration of a diagram of an example graph showing example test results;

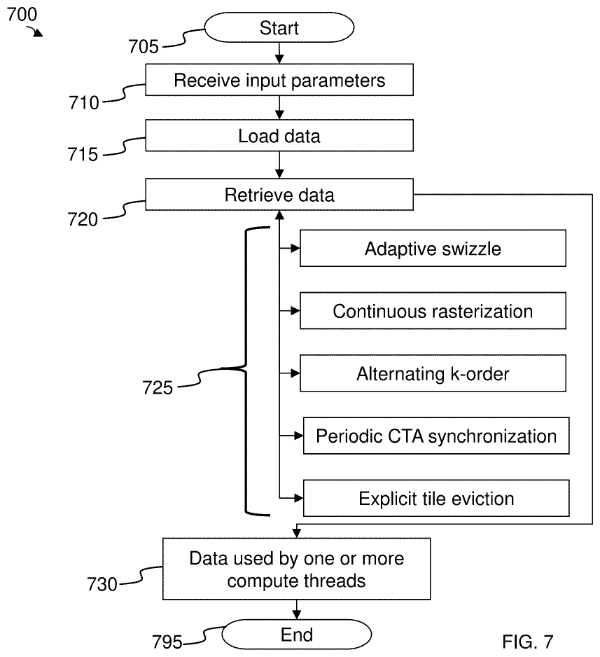

FIG. 7 is an illustration of a flow diagram of an example method to use a CADRE process;

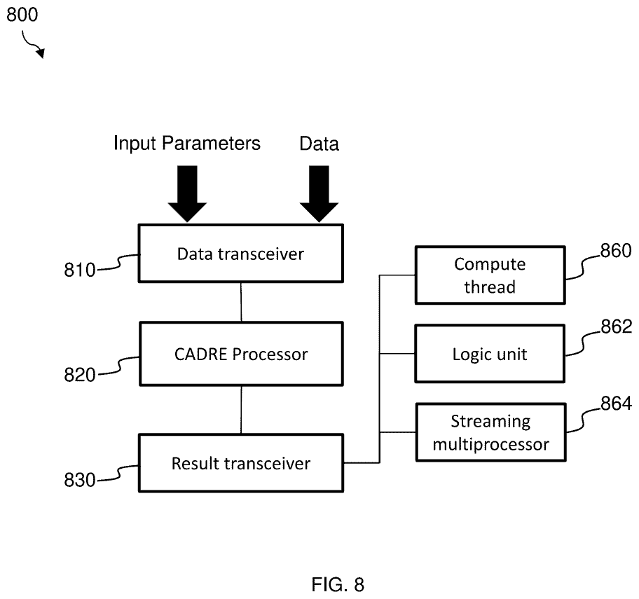

FIG. 8 is an illustration of a block diagram of an example CADRE system; and

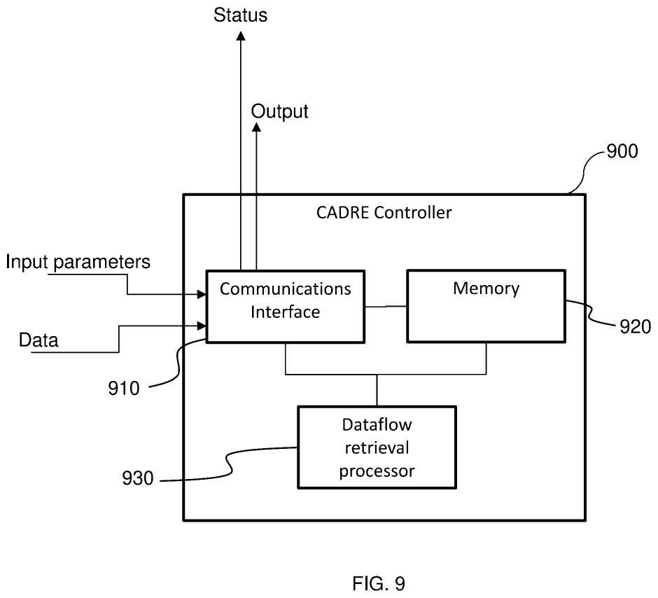

FIG. 9 is an illustration of a block diagram of an example of a CADRE controller according to the principles of the disclosure.

### DETAILED DESCRIPTION

The processor unit used to execute code can be of various types, such as a central processing unit (CPU), a graphics processing unit (GPU), a single instruction multiple data (SIMD) processor, or other types of processor units. For this disclosure, the processor unit can execute at least two concurrent execution threads. The capacity of the logic units of the processor unit to perform thread executions can outpace the ability of the memory bandwidth to retrieve data from external memory locations to support the thread executions. The time it takes to retrieve data from the memory can directly correspond to an increase in the power consumption of the processor unit since more resources are spent retrieving the requested data. The increase in power consumption can result in degraded general processing performance due to power constraints or heat dissipation constraints. This can be pronounced on processor units that use large amounts of power to operate, such as some chips requesting upwards of 700 watts to 1,000 watts.

The processors can have at least some internal memory locations, e.g., memory cache, available to store data. The memory cache can be L1 cache, L2 cache, or other types of memory locations. In some aspects, a processor unit can have more than one L1 cache or more than one L2 cache. To improve the performance of the processor unit, the memory caches are increasing in size so that more data can be stored on the processor unit chip thereby alleviating some of the power and bandwidth constraints of accessing external memory. Accessing the memory cache using a standard method can result in suboptimal performance. Improved data retrieval times can be realized by the processor unit when the data retrieval routines from the memory cache are optimized to the type of data or how the data is being utilized.

This disclosure presents processes to re-organize a data flow of a kernel of the processor unit (e.g., cache-aware dataflow reorganization (CADRE)) to improve the opportunity to reuse data retrieved from memory cache, for example, from L2 cache. CADRE can be a set of dataflow techniques. If more than one memory cache is present on the processor unit, each memory cache can implement the same or different set of CADRE techniques. The retrieved data can be used by a compute thread executing on a logic unit of the processor unit. Faster retrieval times and data reuse can result in improved processor unit performance and reduce the energy consumption for the operation. Large language models (LLMs) are one type of processing on a processor unit that has large data footprints that can take advantage of dataflow re-organization to improve performance. The kernel can be one of various types of kernels, for example, general matrix multiplication (GEMM) kernels.

CADRE can consist of a set of dataflow techniques that can be implemented to improve memory cache data reuse. The techniques are introduced here as algorithm models, such as 1) An adaptive swizzling model; 2) A continuous rasterization model; 3) An alternating K-order model; 4) A periodic CTA synchronization model; or 5) An explicit tile eviction model. In some aspects, these techniques can be implemented independently, or in one or more combinations. In some aspects, the performance can be improved when the software techniques are co-optimized using two or more of the techniques in combination.

In some aspects, one or more techniques (e.g., one or more algorithms) can be specified as input from an application using the processor unit. In some aspects, one or more techniques to use can be specified by a processor unit library, a kernel instruction (e.g., kernel library), or a processor unit ROM. In some aspects, the processor unit can specify a default set of techniques. In some aspects, one or more of the techniques can be implemented using the hardware of the processing unit. In some aspects, one or more of the techniques can be implemented by the software of the processing unit. In some aspects, the one or more techniques that are specified to be used can be changed at each execution cycle of a kernel. In some aspects, a processor unit can utilize heuristics to determine the effectiveness of the techniques and subsequently disable a technique from being used for that application and data set combination when the specific technique is shown to be detrimental to the operational performance of the processor unit (e.g., negatively impacting performance of the processing unit).

The adaptive swizzling model can select the optimal compute grid array (CGA) swizzle size based on one or more of a problem size, a CGA tile size, a grid size, a memory cache capacity, input data types, or a sparsity parameter. As shown in FIG. 1, an analytical model (e.g., a swizzle model) to estimate the total DRAM traffic incurred within a kernel is presented. Using the swizzle model, an equation to determine the optimal swizzle size and rasterization direction for any given software and hardware configuration can be derived. Equation 1 demonstrates an example swizzle model calculation.

$${c}_{min} = max ( 1 , \frac{g}{m} ) \qquad Equation 1 : Example swizzle model calculation$$

$${c}_{max} = min ( g , n )$$

$$if c \leq p , T = n + \frac{n m}{c} , where {T}_{min} = n + \frac{m n}{p} when c = p$$

$$if c > p , T = n + \frac{n m}{c} + \frac{( c - p ) ( \frac{m c}{g} - 1 ) n}{c} = \frac{( m + p ) n}{c} + \frac{( c - p ) m n}{g} ,$$

$$where {T}_{min} = 2 n \sqrt{\frac{m ( m + p )}{g}} - \frac{p m n}{g} when c = \sqrt{\frac{g ( m + p )}{m}}$$

$${c}_{opt} = max ( p , \sqrt{\frac{g ( m + p )}{m}} )$$

where m is the number of CGAs among the M dimension,
n is the number of CGAs along the N dimension,
g is the number of CGAs within a wave,
c is CGA swizzle size,
p is the reusable memory cache capacity for input B,
T is the total amount of data fetched from memory, and
Cₒₚₜ is the optimal CGA swizzle size.

The continuous rasterization model can rasterize CGA waves, using rasterization algorithms, so that neighboring CGA waves obtain maximum data sharing as shown by the example in FIG. 3.

The alternating K-order model can reverse the order in which K blocks are retrieved for every other CGA wave to maximize data hit rate in the memory cache across neighbor waves, as shown in FIG. 4. This aims to avoid the classic drawback of the Least Recently Used (LRU) hardware cache policy used in the memory cache, where if the working set of a wave is slightly larger than the memory cache capacity, then data entries in the memory cache can be discarded just before they need to be reused by the next wave causing very low cache hit rates. By alternating the K order, the cache hit rate between neighbor waves can decrease smoothly as the working set increases.

The periodic CTA synchronization model can periodically, (for example, at wave boundaries) synchronize CTAs on the grid to reduce CTA drift that reduces spatial locality, as shown by the example in FIG. 5. This can be implemented by inserting a program control barrier to sync up active CTAs at wave boundaries. It can leverage two atomic counters, where one can be used to track the number of active CTAs and the other can trace the number of CTAs that have arrived at the program control barrier. The atomic counters can be stored in global memory, such as memory or a memory cache. This model can release the program control barrier when the number of active CTAs is equal to the number of CTAs that have arrived at the program control barrier and then reset the arrive counter to zero (e.g., the last barrier CTA counter corresponding o the last program control barrier if equal to the active CTA counter). In some aspects, there can be more than one program control barrier, each associated with a different processing point of the program flow.

The explicit eviction model can leverage memory cache eviction classes to programmatically promote input data to be memory cache persistent upon first load (e.g., at a first time), and programmatically demote or invalidate after the last use (e.g., at a last time). This technique can dynamically adjust data priority in the memory cache and can result in better memory cache locality. To accurately identify the last loader CTA which can be responsible for data demotion or invalidation after the last use, each input tile can be associated with an atomic loader counter to track its reference count. The atomic loader counter can be located in external memory or the processor unit memory. This can identify the last loader CTA when the CTA completes and the atomic loader counter is at one.

In some aspects, a demotion-based control can be used to reduce DRAM read traffic while not introducing extra instructions. In some aspects, an invalidation-based control can be used to reduce DRAM read and write traffic using extra invalidation instructions in the streaming multiprocessor (SM). In some aspects, the invalidation or demotion can be on a per k-tile basis of the input matrix. In some aspects, each k-tile can be associated with an atomic loader counter where each CTA can issue an atomicinc( ) or equivalent instruction, to this counter after completing a load of this k-tile from global memory to the memory cache. The last CTA can explicitly invalidate or demote the k-tile. In some aspects, a hardware-based counter within the memory cache can be used in place of the global memory.

Turning now to the figures, FIG. 1 is an illustration of a diagram of example swizzling models 100. Rasterizing each CTA wave into a square shape can result in good data reuse from the memory cache. This is hard to achieve in practice due to varying SM counts and problem sizes. Rasterizing techniques need to account for newer hardware and software features, such as larger L2 cache capacities, CGA clusters, a variety of input precisions, or sparsity within a kernel (e.g., applying logic to bypass calculations where a zero is in a matrix).

A model 110 shows an example of a row-major raster order. A model 120 shows an example square wave raster order. A model 130 shows an example column major raster order. In small data sets or in certain applications, these standard raster models can be effective. There are situations where these standard raster orders may not be as efficient as the disclosed processes, especially in larger problem sizes and larger memory cache sizes.

FIG. 2 is an illustration of diagrams of an example adaptive swizzling model 200. Adaptive swizzling model 200 can utilize one or more factors, such as problem size, CGA tile size, grid size, memory cache capacity, input data types, or sparsity. Adaptive swizzling model 200 demonstrates a model 210 where each CGA has equal-sized inputs A and B. In some aspects, the densities of input A and input B can vary with respect to each other and Equation 1 can be extended to include varying the input densities. Adaptive swizzling model 200 and Equation 1 show that improved efficiency can be achieved by selecting the maximum swizzle size where the smaller input of A or B can be fully cached in the memory cache.

FIG. 3 is an illustration of a diagram of an example continuous rasterization model 300. Continuous rasterization model 300 shows a conventional rasterization model 310 and a continuous rasterization model 320. In conventional rasterization model 310, the arrows indicate a ‘z’ pattern for retrieving data from the memory cache. Since data block 3 shares no columns or rows with data block 2, it cannot reuse any loads for data block 2 that are already in the cache. In continuous rasterization model 320, the arrows indicate a box pattern for retrieving data from the memory cache. For each data block 2, 3, and 4, the previously retrieved data block is partially retained improving the chance of being able to reuse those data elements. Continuous rasterization model 320 demonstrates a block pattern through the arrow indications. In other aspects, different continuous rasterization patterns can be used, as long the patterns are continuous and allow for at least a partial overlap with the previously retrieved block of data.

FIG. 4 is an illustration of a diagram of an example alternating K order model 400. Alternating K order model 400 demonstrates that the order in which the K blocks are loaded is reversed in alternating CGA waves to improve the data hit rate in the memory cache. The cache hit rate between neighbor waves can decrease smoothly as the working set increases. This model can result in nondeterminism, such as with floating point addition since that is not associative. K order 410 is indicated by the arrows for the M and N dimensions. K order 430 reverses the arrow direction for an opposite k-direction for alternate waves.

FIG. 5 is an illustration of a diagram of an example periodic CTA synchronization model 500. Periodic CTA synchronization model 500 addresses the issue when CTAs on different SMs can gradually become out of synchronization, especially for larger problem sizes. Inserting a barrier to sync active CTAs at a wave boundary can lead to improved data reuse between the SMs. A set of SMs 510 can request data from the memory cache. A series of barriers 515 can be used to maintain synchronization of the CTAs by using an active CTA counter 520 and a barrier CTA counter 525. Active CTA counter 520 can track the number of active CTAs at a given time. Barrier CTA counter 525 can track the number of CTAs that have reached the specific barrier. A specific barrier within barriers 515 can be released if active CTA counter 520 equals barrier CTA counter 525 at that specific barrier, followed by having the barrier CTA counter reset to zero for that barrier.

FIG. 6 is an illustration of a diagram of an example graph 600 showing example test results. To evaluate the effectiveness of CADRE, CADRE can be included in a library for a GPU. Graph 600 shows the results for problem sizes from the feed-forward network (FFN) layer of the GPU with 4-way tensor parallelism where M (input token number) varies from 2048 to 16384 (e.g., batch_size*sequence_length), and N=K=12288. The results can be obtained on a GPU with 144 SMs, 132 megabytes (MB) of L2 capacity, a fixed clock frequency of 1.8 GHz, and 700 W thermal design power (TDP), where the clock frequency can decrease when power throttling occurs. Graph 600 includes traffic reduction 610 and corresponding performance speedup 630 using different precisions.

Traffic reduction 610 has an x-axis 605 showing the M value being tested for each of the floating point (FP) sizes shown in a key 607. The percentage of DRAM traffic reduction is shown by y-axis 606. Performance speedup 630 has an x-axis 635 showing the M value being tested for each of the FP sizes shown in key 607. The percentage of speedup measured in the testing apparatus is shown in y-axis 636.

Based on the experiments, CADRE may not impact small problem sizes for which the working set can fit in the L2. CADRE can have a large effect on problem sizes that exceed the L2 working set with, in this example testing, a result of up to 84.0% DRAM traffic reduction and 41.0% speedup at M=16 k. For the same problem size, lower precision FP can be less likely to be impacted by the disclosed processes for traffic reduction due to the smaller working set. Lower precision FP can experience a slight slowdown rather than a speedup due to the implementation overhead. As the problem set increases, the slight slowdown is replaced by a tendency to speed up operations. Once the working set exceeds the memory cache capacity, the various FPs tend to receive similar benefits for the same problem size. Improving the efficiency of L2 cache utilization can utilize on-chip resources balancing GPU math throughput, on-chip memory capacities, or off-chip DRAM bandwidth. As parameter counts continue to increase at a faster rate than precision reduction in future LLM models, techniques such as CADRE can be important in achieving overall GPU energy efficiency and performance.

FIG. 7 is an illustration of a flow diagram of an example method 700 to use a CADRE process. Method 700 can be performed on a computing system, for example, CADRE system 800 of FIG. 8 or CADRE controller 900 of FIG. 9. The computing system can be one or more processors in various combinations (e.g., CPUs, GPUs, SIMDs, or other types of processors) capable of executing more than one compute thread at a time, whether located at a data center, a cloud environment, a server, a laptop, a mobile device, a smartphone, or a PDA. Method 700 can be encapsulated in software code or hardware, for example, an application, code library, code module, dynamic link library, module, function, RAM, ROM module, and other software and hardware implementations. The software can be stored in a file, database, or other computing system storage mechanism. Method 700 can be partially implemented in software and partially in hardware. Method 700 can perform the steps for the described processes, for example, using a combination of dataflow techniques to improve data reuse among multiple compute threads executing on a processor unit.

Method 700 starts at a step 705 and proceeds to a step 710. In step 710, input parameters can be received. The input parameters can be a specified list of models to use as the set of dataflow techniques. The input parameter can be the data to be stored in the memory cache. The input parameters can be the data request from a compute thread for a data block.

In a step 715, the data can be stored in the memory cache, if it is not already stored. A dataflow retrieval algorithm can be identified which can be a combination of more than one retrieval model. In a step 720, the requested data block can be retrieved from the memory cache and communicated to one or more compute threads, logic units, or streaming multiprocessors of the processing unit. Step 720 can use one or more models in various combinations as indicated by models 725.

In a step 730, the retrieved data blocks can be used by one or more of the execution processes. In some aspects, an atomic counter can be incremented or decremented, depending on the logic of the selected data flow models currently utilized. Method 700 ends at a step 795.

FIG. 8 is an illustration of a block diagram of an example CADRE system 800. CADRE system 800 can be implemented in one or more computing systems or one or more processors. In some aspects, CADRE system 800 can be implemented using a CADRE controller such as CADRE controller 900 of FIG. 9. CADRE system 800 can implement one or more aspects of this disclosure, such as method 700 of FIG. 7.

CADRE system 800, or a portion thereof, can be implemented as an application, a code library, a dynamic link library, a function, a module, a header file, other software implementations, or combinations thereof. In some aspects, CADRE system 800 can be implemented in hardware, such as a ROM, a graphics processing unit, or other hardware implementation. In some aspects, CADRE system 800 can be implemented partially as a software application and partially as a hardware implementation. CADRE system 800 is a functional view of the disclosed processes, and an implementation can combine or separate the described functions in one or more software or hardware systems.

CADRE system 800 includes a data transceiver 810, a CADRE processor 820, and a result transceiver 830. The output, e.g., the retrieved data blocks, can be communicated to a data receiver, such as one or more compute threads 860, one or more logic units 862, or one or more SMs 764. Other processors can have execution units that vary from this example, as long as the processor supports multi-threading (e.g., a multi-threaded processor), then the disclosed processes can be used.

Data transceiver 810 can receive the input parameters, including the heuristics on past executions that can be used to determine if a technique (e.g., model) should be disabled for the execution of the current set of compute threads, and a specification on the models to use for the data retrieval process. In some aspects, data transceiver 810 can be part of CADRE processor 820. Data transceiver 810 can receive the data to be stored in the memory cache. Data transceiver 810 can receive the request to retrieve a data block, such as from a compute thread, logic unit, or SM.

Result transceiver 830 can communicate one or more outputs (e.g., data blocks), to one or more data receivers, such as compute threads 860, one or more logic units 862, one or more SMs 864, or other related execution units. Data transceiver 810, CADRE processor 820, and result transceiver 830 can be, or can include, conventional interfaces configured for transmitting and receiving data, such as processor unit buses. Data transceiver 810, CADRE processor 820, or result transceiver 830 can be implemented as software components, as hardware components, or combinations of software and hardware components and functionality. The functionality described for these components remains intact regardless of how the functionality is implemented.

CADRE processor 820 can implement the analysis and algorithms as described herein utilizing the input parameters. In some aspects, CADRE processor 820 can include a dataflow processor, capable of retrieving one or more blocks of data from the memory cache when requested by the logic unit of the processor unit, wherein the dataflow processor utilizes a data retrieval model comprising one or more of an adaptive swizzling model, a continuous rasterization model, an alternating k-order model, a periodic CTA synchronization model, or an explicit tile eviction model. The processor unit can include more than one memory cache, and each memory cache can utilize a different data retrieval model. CADRE processor 820 can include more than one logic unit each of which can execute more than one compute thread. CADRE processor 820 can include more than one streaming multiprocessor.

CADRE processor 820 can be one or more of code executing on a processor, a dedicated hardware component, a multicore processor, a multiprocessor system, or a streaming multiprocessor. CADRE processor 820 can be implemented by a CPU, a GPU, or other types of processors.

A memory or data storage system of CADRE processor 820 (such as a core cache, L1 cache, L2 cache, or other memory systems) can be configured to store the processes and algorithms for directing the operation of CADRE processor 820. CADRE processor 820 can include a processor that is configured to operate according to the analysis operations and algorithms disclosed herein, and an interface to communicate (transmit and receive) data. Data transceiver 810, result transceiver 830, and CADRE processor 820 can be logic, circuits, or software of one processor unit.

FIG. 9 is an illustration of a block diagram of an example of a CADRE controller 900 according to the principles of the disclosure. CADRE controller 900 can be part of a processor unit. The various components of CADRE controller 900 can communicate via wireless or wired conventional connections, such as processor unit buses. A portion or a whole of CADRE controller 900 can be located at one or more locations within the processor unit. For example, the dataflow retrieval processor can be separate from the memory cache components. CADRE controller 900 represents a demonstration of the functionality employed for the disclosure, and implementations can use a variety of devices, for example, circuits of a processor, dedicated processors, virtual systems, software or hardware, or various combinations thereof.

CADRE controller 900 can be configured to perform the various functions disclosed herein including receiving input parameters and generating results from the execution of the methods and processes described herein, such as determining the dataflow retrieval models to use to retrieve data blocks for compute threads. CADRE controller 900 includes a communications interface 910, a memory 920 (e.g., memory cache), and a dataflow retrieval processor 930.

Communications interface 910 is configured to transmit and receive data. For example, communications interface 910 can receive the input parameters. Communications interface 910 can transmit the retrieved data blocks to the requesting compute threads. In some aspects, communications interface 910 can transmit a status, such as a success or failure indicator of CADRE controller 900 regarding receiving the various inputs, transmitting the generated outputs, or producing the results.

In some aspects, dataflow retrieval processor 930 can perform the operations as described by CADRE processor 820. Communications interface 910 can communicate via communication systems used in the industry. For example, wireless or wired protocols can be used. Communication interface 910 is capable of performing the operations as described for data transceiver 810 and result transceiver 830 of FIG. 8.

In some aspects, memory 920 can be configured to store a series of operating instructions that direct the operation of dataflow retrieval processor 930 when initiated, including supporting code representing the algorithm for implementing the CADRE process. Memory 920 is a non-transitory computer-readable medium. Multiple types of memory can be used for the data storage systems and memory 920 can be distributed. Memory 920 can be the memory cache or part of the memory cache. In some aspects, memory 920 can be part of global memory, for example, to store the atomic counters.

Dataflow retrieval processor 930 can be one or more logical units within the processor unit. Dataflow retrieval processor 930 can be a virtual process. Dataflow retrieval processor 930 can be dedicated circuitry within a processor. Dataflow retrieval processor 930 can be a code process running on a processor unit. Dataflow retrieval processor 930 can be configured to produce the output, one or more interim outputs, and statuses utilizing the received inputs. Dataflow retrieval processor 930 can determine the output using parallel processing.

In some aspects, dataflow retrieval processor 930, communications interface 910, memory 920, or various combinations thereof, can be an integrated circuit. Dataflow retrieval processor 930 can be configured to direct the operation of CADRE controller 900. Dataflow retrieval processor 930 includes the logic to communicate with communications interface 910 and memory 920, and perform the functions described herein. Dataflow retrieval processor 930 is capable of performing or directing the operations as described by CADRE processor 820 of FIG. 8. In some aspects, CADRE system 800 or CADRE controller 900 can be part of a machine learning system, such as using past-learned heuristics to determine the models to use as the set of dataflow techniques for various types of data and application processing.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on one chip. Configured or configured to means, for example, designed, constructed, or programmed, with the necessary logic and/or features for performing a task or tasks.

Portions of disclosed examples or embodiments may relate to computer storage products with a non-transitory computer-readable medium that has program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher-level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. A method, comprising:
receiving input parameters, wherein the input parameters specify one or more algorithms to be used for a cache-aware dataflow within a processor unit;
loading data into a memory cache during an execution of an application executing on a processor unit; and
retrieving the data utilizing the one or more algorithms, wherein the data is stored using a swizzle model and the data is retrieved in data blocks, where the one or more algorithms are one or more of an adaptive swizzling model, a continuous rasterization model, an alternating k-order model, a periodic compute thread array (CTA) synchronization model, or an explicit tile eviction model.

2. The method as recited in claim 1, wherein the processor unit has at least one memory cache using the cache-aware dataflow.

3. The method as recited in claim 1, wherein the input parameters are received from the application.

4. The method as recited in claim 1, wherein the retrieving uses a combination of at least two of the one or more algorithms.

5. The method as recited in claim 1, wherein the processor unit utilizes heuristics to determine at least one technique of the one or more algorithms is negatively impacting performance of the processing unit and the at least one technique is disabled for use by the retrieving for a combination of the application and the data.

6. The method as recited in claim 1, wherein the one or more algorithms includes the adaptive swizzling model, further comprising:
computing a compute grid array (CGA) swizzle size utilizing one or more of a problem size, a CGA tile size, a grid size, a capacity of the memory cache, a type of the data, or a sparsity parameter; and
using the CGA swizzle size in the retrieving.

7. The method as recited in claim 1, wherein the one or more algorithms includes the continuous rasterization model, further comprising:
rasterizing CGA waves to enable neighboring CGA waves to share data; and
using the CGA waves in the retrieving.

8. The method as recited in claim 1, wherein the one or more algorithms includes the alternating k-order model, further comprising:
reversing an order that k blocks are retrieved for each subsequent CGA wave; and
using the order of the k blocks in the retrieving.

9. The method as recited in claim 1, wherein the one or more algorithms includes the periodic CTA synchronization model, further comprising:
setting an active CTA counter to a number of active CTAs and a barrier CTA counter to the number of active CTAs that have arrived at a program control barrier;
releasing the program control barrier when the active CTA counter equals the barrier CTA counter; and
resetting the active CTA counter to zero and the barrier CTA counter to zero.

10. The method as recited in claim 9, wherein the program control barrier is a first program control barrier and at least one additional program control barrier is implemented each with a respective barrier CTA counter, the resetting resets the active CTA counter to zero when a last barrier CTA counter corresponding to a last program control barrier of the at least one additional program control barrier is equal to the active CTA counter, and each of the at least one additional program control barrier is located at a different processing point of a compute thread.

11. The method as recited in claim 1, wherein the one or more algorithms includes the explicit tile eviction model, further comprising:
promoting the data to be memory cache persistent at a first time the data is first retrieved;
incrementing an atomic loader counter for each active CTA using the data;
decrementing the atomic loader counter when an active CTA no longer uses the data; and
demoting the data to remove it from a working memory when the atomic loader counter is decremented to zero.

12. The method as recited in claim 11, wherein the data represents a k-tile.

13. The method as recited in claim 11, wherein the atomic loader counter is a hardware-based counter within the processor unit.

14. A system, comprising:
a memory cache capable of storing data from an application; and
a logic unit capable of executing at least one compute thread, wherein the compute thread requests data using data blocks from the memory cache using a set of dataflow techniques that include at least one of an adaptive swizzling model, a continuous rasterization model, an alternating k-order model, a periodic compute thread array (CTA) synchronization model, or an explicit tile eviction model.

15. The system as recited in claim 14, wherein the logic unit is part of a graphics processing unit (GPU).

16. The system as recited in claim 14, wherein the memory cache and the logic unit are located as part of a processor unit.

17. The system as recited in claim 14, wherein the memory cache is at least one L2 memory cache.

18. The system as recited in claim 14, wherein the memory cache is a first memory cache and the system includes more than one memory cache and each memory cache utilizes a separate set of dataflow techniques.

19. The system as recited in claim 14, wherein the logic unit utilizes a general matrix multiplication (GEMM) kernel.

20. The system as recited in claim 14, further comprising:
a global memory, capable of storing at least one atomic counter to be utilized by at least one dataflow technique in the set of dataflow techniques.

21. A non-transitory computer program product having a series of operating instructions stored on a non-transitory computer-readable medium that directs data retrieval from a memory cache of a processor unit when executed, operations comprising:
receiving input parameters, wherein the input parameters specify one or more algorithms to be used as a cache-aware dataflow within the processor unit, and the processor unit is a multi-threaded processor;
loading data into the memory cache during an execution of an application executing on the processor unit; and
retrieving the data utilizing the one or more algorithms, wherein the data is stored using a swizzle model and the data is retrieved in data blocks, where the one or more algorithms are one or more of an adaptive swizzling model, a continuous rasterization model, an alternating k-order model, a periodic compute thread array (CTA) synchronization model, or an explicit tile eviction model.

22. The non-transitory computer program product as recited in claim 19, wherein the input parameters are received from one of a kernel library or a processor unit ROM associated with the processor unit.

23. A processor unit, comprising:
a memory cache, capable of storing data from an execution of an application by a compute thread of the processor unit;
a logic unit, capable of executing the compute thread and requesting the data from the memory cache; and
a dataflow processor, capable of retrieving one or more blocks of data from the memory cache when requested by the logic unit, wherein the dataflow processor utilizes a data retrieval model comprising one or more of an adaptive swizzling model, a continuous rasterization model, an alternating k-order model, a periodic compute thread array (CTA) synchronization model, or an explicit tile eviction model.

24. The processing unit as recited in claim 21, wherein the memory cache is a first memory cache, and the processor unit comprises at least one additional memory cache, and each memory cache utilizes a different data retrieval model.

25. A processing unit system, comprising:
a memory cache, capable of storing data from an execution of an application by a compute thread of a processor unit;
a logic unit, capable of executing the compute thread and requesting the data from the memory cache;
a dataflow processor, capable of retrieving one or more blocks of data from the memory cache when requested by the logic unit, wherein the dataflow processor utilizes a data retrieval model comprising one or more of an adaptive swizzling model, a continuous rasterization model, an alternating k-order model, a periodic compute thread array (CTA) synchronization model, or an explicit tile eviction model; and
a global memory, capable of storing at least one atomic counter used by at least one model in the data retrieval model.

26. The processing unit system as recited in claim 23, wherein the processing unit system includes more than one logic unit and includes more than one streaming multiprocessor (SM), and the dataflow processor retrieves the data for each SM in the more than one SM.
